(19) United States
(12) Patent Application Publication
(10) Pub. No.: US 2012/0301648 A1
(43) Pub. Date: Nov. 29, 2012

(54) Biodegradable Expanded Polystyrene Foam And Method For Its Production

(75) Inventor: Michel Serge Maxime Lefebvre, Kurrajong (AU)

(73) Assignee: SAFEPS PTY LTD., North Rocks, New South Wales (AU)

(21) Appl. No.: 13/505,955

(22) PCT Filed: Nov. 18, 2010
(86) PCT No.: PCT/AU2010/001546

§ 371 Date: Aug. 15, 2012

(30) Foreign Application Priority Data
Nov. 24, 2009 (AU) 2009905759

(51) Int. Cl. C08J 9/224; B32B 1/02; C08G 18/06; B05D 1/04; C08F 112/08; C08J 9/228

(52) U.S. Cl. 428/36.5; 521/57; 521/53; 521/54; 427/458

(57) ABSTRACT

There is disclosed unexpanded or pre-expanded polystyrene beads electrostatically coated with a media capable of supporting the growth of bacteria which assist in the decomposition of the polystyrene. There is also disclosed methods of making the beads, a method of making an expanded polystyrene foam and an expanded polystyrene foam prepared by the method.

### TECHNICAL FIELD

The present invention relates to a biodegradable expanded polystyrene foam and a method for its production. The present invention also related to coated polystyrene unexpanded or pre-expanded beads suitable for the production of the biodegradable expanded polystyrene foam.

### BACKGROUND OF THE INVENTION

The information provided herein and references cited herein and later in this document are provided solely to assist the understanding of the reader, and do not constitute an admission that any of the references or information is prior art to the present invention.

Synthetic polymeric foams such as expanded polystyrene (EPS) are used widely in both industry and home, for example in flotation devices, insulation, boxes, plates and disposable cups. EPS is a thermoplastic closed cell, light weight, rigid form plastic, having the advantage of low thermal conductivity, high compressive strength, excellent shock absorption and the ability to support many times its own weight in water. EPS is typically made by a suspension polymerisation process in which styrene globules (suitably prepared by combining ethylene and benzene in the presence of a catalyst) is suspended in water and polymerised under heat using an initiator to form tiny, hard polystyrene beads. The polymerisation process is terminated once a polymer chain of the desired length is formed. The tiny, hard polystyrene beads are then expanded to produce the EPS product. To produce a smooth-skinned expanded polystyrene foam, prior to expansion the beads are suitably pre-expanded by heating the polystyrene either with steam or hot air to dramatically reduce their density. Blowing agents such as propane, pentane, methylene chloride or CFC's are suitably used. The resulting beads are then typically allowed to cool and harden and the beads then fed into a mold of desired shape. Low-pressure steam is then suitably injected into the mold further expanding the beads resulting in fusion of the beads and formation of the final product.

Polystyrene foams provide numerous benefits but suffer from the disadvantage that they pose a significant environmental disposable problem due to their xenobiotic nature and toxicity. Even in cultivated soils containing a wide range of fungi, microbes and invertebrates, degradation of polystyrene is less than 1% after 90 days with no significant increase in degradation after this time (David L. Kaplan, Roy Hartenstein and Jim Sutter. Biodegradation of Polystyrene, Poly(methyl methacrylate), and Phenol Formaldehyde. Applied and Environmental Microbiology, 1979, p 551-553).

Recently, additives capable of undergoing oxidative degradation (such as polysaccharides) have been added to the base resin. These additives have resulted in faster degradation than untreated products with a break-down of products into singular cells but without true biodegradation of the remaining polystyrene resin as the additives only weaken the bonds between the cells.

Another feature of the manufacture of polystyrene foams is the use of anti-caking agents such as zinc oxalates to avoid clumping during expansion. Anti-caking agents such as zinc oxalates have antiseptic properties and the ability to kill bacteria but these properties are undesirable as they prevent the biodegradation of polystyrene.

Despite many attempts, true biodegradation of polystyrene foams in a reasonable time frame has not been achieved to date. It would be desirable to provide a polystyrene foam that is capable of biodegradable in a reasonable time frame.

### OBJECT OF THE INVENTION

It is an object of the present invention to substantially overcome or at least ameliorate one or more of the above disadvantages or at least provide a suitable alternative.

### DEFINITIONS

The following are some definitions that may be helpful in understanding the description of the present invention. These are intended as general definitions and should in no way limit the scope of the present invention to those terms alone, but are put forth for a better understanding of the following description.

Unless the context requires otherwise or specifically stated to the contrary, integers, steps, or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of elements or integers. Thus, in the context of this specification, the term “comprising” means “including principally, but not necessarily solely”.

By “biodegradable” is meant biodegradability in accordance with the ISO 472 definition namely “a plastic designed to undergo a significant change in its chemical structure under specific environmental conditions resulting in a loss of some properties that may vary as measured by standard test methods appropriate to the plastic and the application in a period of time that determines its classification. The change in the chemical structure results from the action of naturally occurring microorganisms”.

### SUMMARY OF THE INVENTION

According to a first aspect of the present invention, there is provided unexpanded or pre-expanded polystyrene beads electrostatically coated with a media capable of supporting the growth of bacteria which assist in the decomposition of the polystyrene.

According to a second aspect of the present invention, there is provided a method of making the coated unexpanded or pre-expanded polystyrene beads according to the first aspect, the method comprising electrostatically coating, unexpanded or pre-expanded polystyrene beads with a media capable of supporting the growth of bacteria which assist in the decomposition of the polystyrene.

According to a third aspect of the present invention, there is provided a method of making an expanded polystyrene foam comprising expanding unexpanded or pre-expanded beads of the first aspect or made by the method of the second aspect, under heat and optionally in a mold to form an expanded polystyrene foam.

According to a fourth aspect of the present invention, there is provided an expanded polystyrene foam prepared by the method of the third aspect.

### BRIEF DESCRIPTION OF THE DRAWINGS

A preferred embodiment of the present invention will now be described, by way of an example only, with reference to the accompanying drawings wherein:

FIG. 1 is a photograph of polystyrene beads before pre-expansion and a pre-expanded polystyrene bead;

FIG. 2 is a photograph showing a semi monolayer of polyamide particles at the surface of the pre-expanded beads;

FIG. 3 are photographs showing repartition of polyamide microspheres at the surface of pre-expanded polystyrene beads at 2% concentration (w/w);

FIG. 4 is a photograph of washed cups after 4 weeks of soil contact (original left, treated in accordance with the invention at 2% right);

FIG. 5 is a photograph of cups placed in contact with sweetened tea solutions (original bottom, top cup treated in accordance with the invention); and

FIG. 6 is a photograph of wall fracture of an untreated cup (left) and a cup treated in accordance with the invention (right).

### DETAILED DESCRIPTION OF THE PREFERRED EMBODIMENTS

The present invention relates to unexpanded or pre-expanded polystyrene beads electrostatically coated with a media capable of supporting the growth of bacteria which assist in the decomposition of the polystyrene.

The present invention also relates to a method of making the coated unexpanded or pre-expanded polystyrene beads according to the first aspect, the method comprising electrostatically coating unexpanded or pre-expanded polystyrene beads with a media capable of supporting the growth of bacteria which assist in the decomposition of the polystyrene.

The present invention also relates to a method of making an expanded polystyrene foam comprising expanding unexpanded or pre-expanded beads of the invention or made by the method of the invention, under heat and optionally in a mold to form an expanded polystyrene foam.

The present invention also relates to an expanded polystyrene foam prepared by the method.

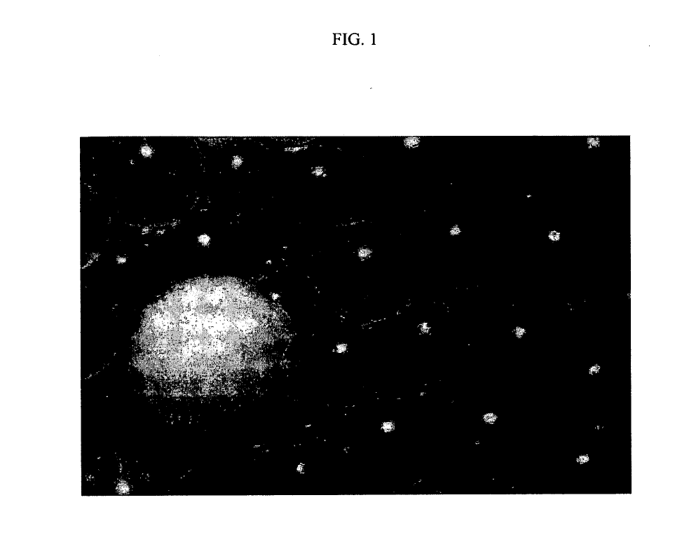

In one embodiment, the unexpanded or pre-expanded polystyrene beads are coated with the media electrostatically. In this regard unexpanded or pre-expanded polystyrene beads used may be used as delivered by the manufacturer. In such beads during the pre-expansion operation, raw material resin in the form of small unexpanded polystyrene beads typically ranging in size from 0.5 to 1.5 μm expand in volume several times and develop a strong electrostatic charge. Non-expanded beads typically have a very strong electrostatic charge. Electrostatic charge between the unexpanded bead and the media is suitably controlled by monitoring the moisture level of the media. Pre-expansion is typically conducted using heated air or steam. It is a feature of this invention, at least in one embodiment, that the electrostatic charge is used to attract the media capable of supporting bacterial growth onto the surface of the pre-expanded beads. In one embodiment, the pre-expanded beads may have been stored and aged however this is less desirable as the beads may lose shape. FIG. 1 shows the raw material resin in the form of small polystyrene beads and a pre-expanded bead suitable for use in the present invention. The moisture content of the media may be adjusted so as to vary the electrostatic charge so that the media will stick or adhere to the polystyrene beads. A typical suitable moisture content will be around 1% when the media is based on polyamide powders. Moisture content is generally controlled at the factory during the drying process of the raw material. Suitably the media contains some moisture and is not totally dry so that there is little fly-away of the media during coating.

In one embodiment, the media capable of supporting bacterial growth is chosen such that it has a melting point below the temperature used in a subsequent molding process. In one embodiment the media is chosen so that it provides fast biodegradation of polystyrene by bacterial organisms, especially those of the Pseudomonas family. In one embodiment, the media is one chosen that is able to support growth of pseudomonas or any other bacterial species known to degrade polystyrene. This can be established by Culturing the bacterial species and applying the culture to the media and measuring differential gross weight. In one embodiment, the media capable of supporting bacterial growth is a polymer containing CO-NH groups such as a polyamide. Suitable polyamides include, but are not limited to, polyamide 6 or polyamide 12. In one embodiment, the polyamide is prepared by a phase inversion process to provide an open structure similar to a sponge. In one embodiment the polyamide is further chosen to have a CO-NH group density and a chain compaction to allow quick development of microorganisms. In this regard, it has been found that polyamide media is suitable for the culture of Pseudomonas sp. and Bacillus sp. for styrene decomposition and Xanthomonas sp. and Sphingobacterium sp. for polystyrene decomposition. Other suitable media for supporting bacterial growth are as described in Oikawa Eisaku, Linn K. T, Endo Takeshi, OikaWa Taneaki, Ishibashi Yoshinobu “Isolation and Characterization of Polystyrene Degrading Microorganisms for Zero Emission Treatment of Expanded Polystyrene” Proceedings of Environmental Engineering Research. Vol 40, 2003, p 373-379.

In one embodiment, the media capable of supporting bacterial growth is in the form of microparticles or a micropowder. The present inventors have found that polyamides when sufficiently divided are a suitable breeding media for microorganisms such as Pseudomonas. In one embodiment the media are micron size. In one embodiment the powder has a diameter of 5 to 50 microns, for example about 20 microns. In one embodiment the mean diameter is chosen to be less than 50 times the mean diameter of the unexpanded or pre-expanded beads. In another embodiment, the media suitably has a diameter of at least 20 times smaller than that of the unexpanded or pre-expanded beads thereby resulting in a discontinuous monolayer of the media at the surface of the unexpanded or pre-expanded beads.

In one embodiment 0.1 wt % to 5 wt % of a media such as micro-sized polyamide powder based on the total weight of powder plus polystyrene is used as the media. In this regard, too much additive (i.e., more than 5% w/w) may result in a sticking effect during cup forming, but too little additive (less than 1 wt %) gives an un-even coating. In one embodiment, the polyamide is equilibrated with its natural moisture content to achieve electrostatic discharge at the surface of the pre-expanded beads for uniform repartition. In one embodiment the amount of polyamide used is increased as the diameter of the polystyrene beads used is increased.

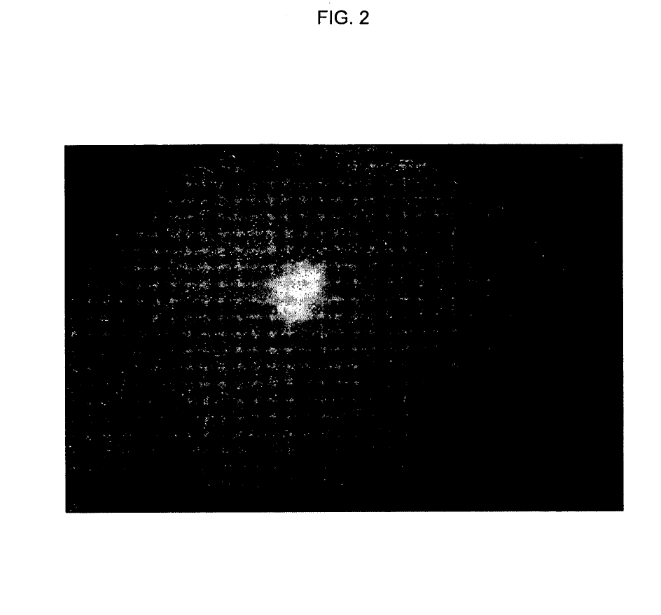

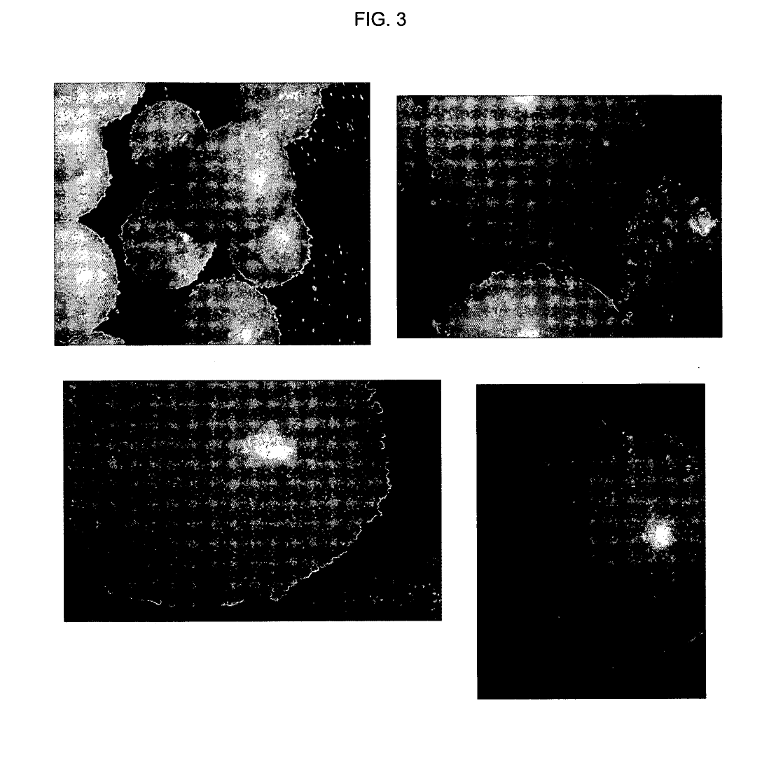

In another embodiment the media is then mixed with a less than 100-micron diameter starch powder at a concentration of between 1% to 20 wt. %. The unexpanded or pre-expanded polystyrene beads may be combined with the media by use of a mixer. FIG. 2 shows a pre-expanded bead containing a monolayer of polyamide dust at the surface of the pre-expanded beads. FIG. 3 shows repartition of polyamide microspheres at the surface of pre-expanded polystyrene beads at 2% concentration (w/w).

In one embodiment the coated unexpanded or pre-expanded beads are molded into a suitable shape before expansion. The coated unexpanded or pre-expanded beads are then expanded using the standard method as would be followed for untreated beads. During expansion, the beads under heat typically swell to almost 50 times their original size with rapid release of the contained gas from the bead when the polymer is heated through its glass transition phase.

In one embodiment, the type of polyamide and its degree of polymerization is chosen such that is melting point temperature is between the maximum temperature used during the pre-expansion or expansion (and any following drying process) and the minimum temperature of the coolest part of the surface of the mold during the high temperature phase of any subsequent molding process.

Polystyrene products made by the invention have the advantage that they break-down in a period of months to bead size elements that are capable of further biodegradation. The polystyrene breaks down rapidly due to the biodegradability of the powder or powder mix and the development of microbial species at the surface of each bead thereby achieving long term biodegradation of the polystyrene or styrene beads. Another advantage is that the use of anti-caking agents such as zinc oxalates can be reduced or are not required. The method may therefore be performed in the absence of any anti-caking agent.

The expanded polystyrene foam may be molded into products such as biodegradable disposable cups.

The invention will now be described by way of the following non-limiting example:

### Example 1

Pre-expanded polystyrene beads suitable for preparing expanded polystyrene foam disposable cups were used. Unexpanded beads obtained from Ineous Nova having a size of approximately 200 μm (see FIG. 2) were pre-expanded under steam resulting in pre-expanded beads having a size of approximately 600 μm (the size was non-uniform). The pre-expanded beads were coated with 2% (w/w) polyamide particles having an average particle diameter of 20 microns, a specific surface area of 5 m²/gram, an apparent density of between 0.35 to 0.38 gram/cm³, with a melting point of 142 to 144° C. and with a residual moisture content of 2%. A photograph of these beads is shown in FIGS. 2 and 3. The coated pre-expanded polystyrene beads were then placed in a cup mold and expanded (suitably under steam) to form expanded polystyrene foam cups each having a weight of about 2 g. Cup formation was satisfactory with a very slight excess of additive present as a residual.

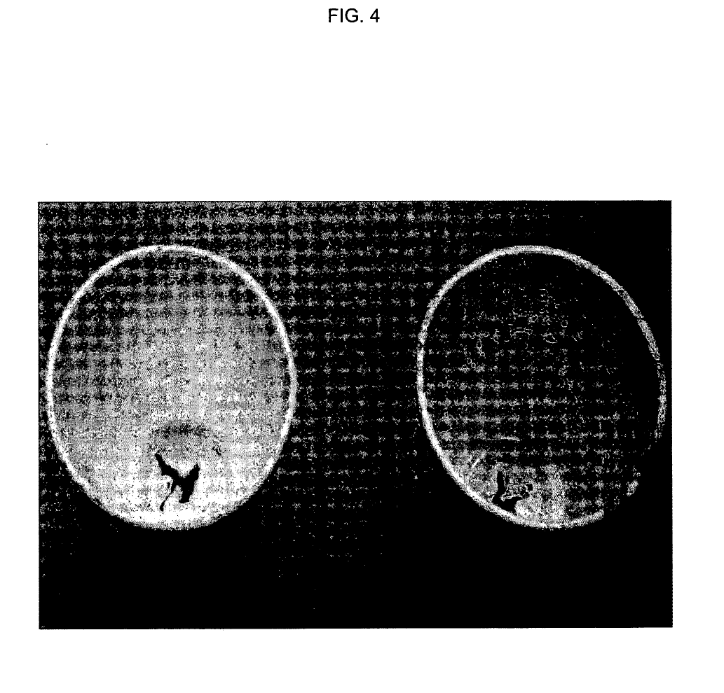

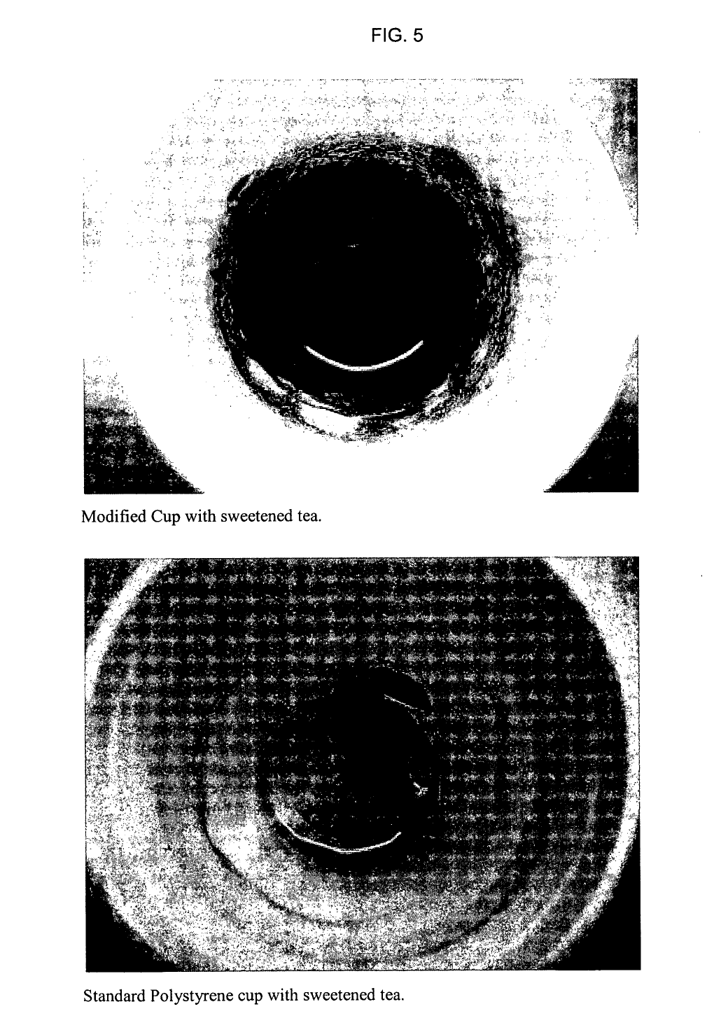

The cups were compared with standard polystyrene cups prepared using uncoated beads. It was found that there was no difference between the cups with respect to their ability to contain water, however when the cups were placed in contact with water for more than 48 hours, a change in surface tension was observed with the cups of the present invention becoming wettable in microzones where the concentration of polyamide was greater (when the surface of the liquid in the cups was moved, a dye solution wet the wall of the modified cup, creating a series of small interfacial bubbles). It was also found that the coated cups in accordance with the present invention biodegraded in a compost in a matter of months. This is clearly seen from FIG. 4 which shows a photograph of a polystyrene cup made in accordance with the invention (right side) with bacterial growth clearly present on the cup whereas an uncoated cup contained significantly less bacteria. FIG. 5 shows clearly the difference in bio-film formation and adhesion between the modified cup according to the invention and the standard polystyrene cup when left in contact with a sweetened tea solution for an extended period.

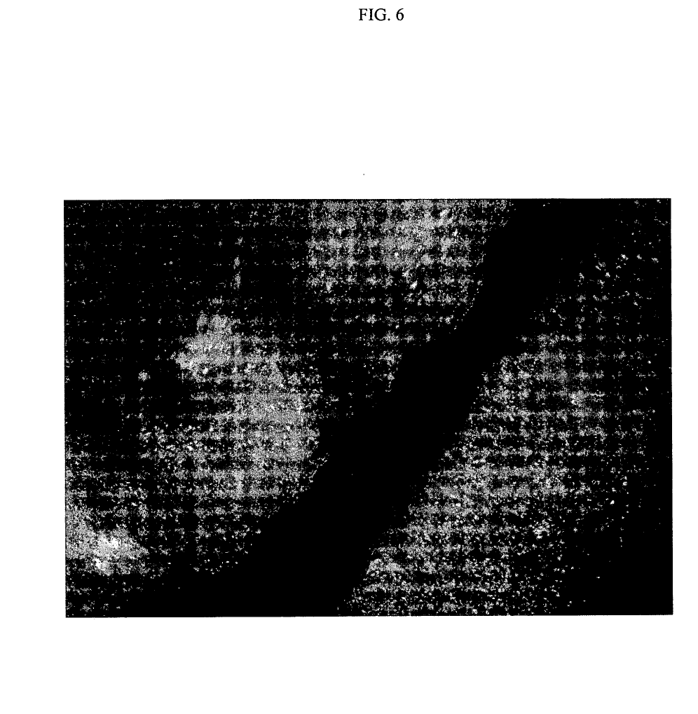

A study of wall fracture was also undertaken. It was found that the untreated cup is fractured along cell lines however the treated cup in accordance with the present invention is fractured across the cell line showing very good adhesion and the diffusion of the additive to form a surface alloy. Reference is made to FIG. 6 which shows structure of wall fracture of new cups. It can be seen that the untreated cup (left image) is fractured along cells line whereas the treated cup (right image) is fractured across the cells line.

Various changes, modifications, improvements and additions may be made to the above embodiments and which fall within the spirit and scope of the invention.

1. Unexpanded or pre-expanded polystyrene beads electrostatically coated with a media capable of supporting the growth of bacteria which assist in the decomposition of the polystyrene.

2. A method of making the coated unexpanded or pre-expanded polystyrene beads according to claim 1, the method comprising electrostatically coating unexpanded or pre-expanded polystyrene beads with a media capable of supporting the growth of bacteria which assist in the decomposition of the polystyrene.

3. The method according to claim 2 wherein the electrostatic charge is controlled by adjusting the moisture content of the media.

4. A method of making an expanded polystyrene foam comprising expanding the unexpanded or pre-expanded beads of claim 1 under heat to form an expanded polystyrene foam.

5. The method according to claim 4 wherein the expansion is conducted under steam.

6. An expanded polystyrene foam prepared by the method of claim 4.

7. The expanded polystyrene foam according to claim 6 in the form of a biodegradable disposable cup.

8. The method according to claim 4 wherein expanding is conducted in a mold.

9. The expanded polyurethane foam according to claim 6 wherein the expansion is conducted under steam.

10. The beads of claim 1 wherein the media comprises a polyamide.

11. The beads of claim 1 wherein the media is in the form of microparticles or a powder.

12. The beads of claim 11 wherein the powder has a particle diameter of 5 to 50 microns.

13. The beads of claim 1 wherein the media has a diameter at least 20 times smaller than that of the beads.
